(19) United States
(12) Patent Application Publication
(10) Pub. No.: US 2015/0337725 A1
(43) Pub. Date: Nov. 26, 2015

(54) Combined driving system of an electric energy generator with the utilization of the pressure potential of a high-energy medium generated in the form of a mixture of exhaust gases and compressed air with the aid of a motor with rocking pistons with an integrated compressor section

(71) Applicants: Jiri Frolik, (US); Ceské vysoké ucení technické v Praze, Praha (CZ)

(72) Inventors: Jiri Frolik, Praha (CZ); Jiri Nozicka, Praha (CZ); Renata Hruba, Praha (CZ)

(73) Assignees: Jiri Frolik, Praha (CZ); Ceské vysoké ucení technické v Praze, Praha (CZ)

(21) Appl. No.: 14/120,131

(22) PCT Filed: Oct. 26, 2012
(86) PCT No.: PCT/CZ2012/000108

§ 371 Date: Apr. 28, 2014

(30) Foreign Application Priority Data
Oct. 26, 2011 (CZ) PV 2012-688

(51) Int. Cl. F02B 53/14; F02B 63/04; F01C 9/00

(52) U.S. Cl. CPC F02B 53/14; F01C 9/00; F02B 63/042

(57) ABSTRACT

The essence of the solution resides in that an internal combustion engine with rocking pistons is constituted by a shared working space in a shared housing (1) of the motor and a compressor in the central portion of which there are formed in a mirrored fashion combustion chambers (2, 2.1) containing rocking blades (3, 3.1) of the motor that are rigidly radially supported on a turnable central shaft (4) and in a carrier ring (4.1) and wherein the rocking blades (3, 3.1) are to advantage mutually angled with respect to each other and wherein the combustion chambers (2, 2.1) are delimited on the one side by delimiting partitions (5, 5.1) radially disposed at the inner circumferential surface of the shared housing (1) of the motor and the compressor and separating the combustion chambers (2, 2.1) from primary compressor chambers (6, 6.1) of the primary compressor part, and on the opposite side by a pair of rocking blades (3, 3.1) at the locations of their lower dead centers, and wherein on the opposite side of the pair of rocking blades (3, 3.1) there are formed secondary compressor chambers (7, 7.1) of a secondary compressor part delimited by end parts of a guiding segment (18) provided with secondary suction and outlet channels (19, 19.1) of a secondary compressor and wherein the turnable central shaft (4) extends with its end portions into external housings (1.1, 1.2) of a crankshaft mechanism that are connected in a mirror fashion to the shared housing (1) of the motor and the compressor, where the turnable central shaft (4) is provided with an oscillating yoke (8) having arms that are connected by means of a pair of piston rods (9, 9.1) with a pair of crankshafts (10, 10.1) on the outer ends of which there is supported a pair of flywheels (11, 11.1) that are provided on their peripheries with coils (12, 12.1) of a stator winding. A pressurized mixing chamber (17) that is connected to the outlet (28) of the exhaust gases from the rocking motor and to the outlet (29) of the pressurized air from the compressor part is provided with a main outlet (22) for the energy medium that is connected to the working expansion machine (23) that is connected with a working generator (25) of electric current, and the collection mixing chamber (17) is connected by a relief outlet (18) for the energy medium to an inlet (19) of a relief expansion machine (20) that is connected to a relief generator (21) of electric current that is electrically connected with coils (12, 12.1) of a stator winding. The combined driving system can be used primarily for the driving of generators of electric current, but its use is not limited to the driving of mobile machines and other apparatuses requiring rotary motion for their operation.

### TECHNICAL FIELD

The invention relates to a combined driving system of an electric energy generator with the utilization of the pressure potential of a high-energy medium generated in the form of a mixture of exhaust gases and compressed air with the aid of a motor with rocking pistons with an integrated compressor section, wherein the thus obtained medium is accumulated in a thermally insulated chamber, from where it is conveyed as a work medium into expansion driving units, such as turbines, rotary machines with orbiting blades and similar driving apparatuses suitable for driving a generator of electric energy, but possibly even for driving other machine apparatuses inclusive of mobile machines.

### CURRENT STATE OF THE ART

In conventional constructions of internal combustion engines with such an arrangement of pistons that they conduct a sliding reciprocating motion in cylinders and are connected by means of piston rods with a crankshaft, it is in certain specific cases considered to be not quite ideal how the torque is taken off, mainly because of considerable mechanical losses that arise in the course of this kind of torque take-off. These disadvantages have gradually led to the proposals of new constructions of internal combustion engines, such as, for example, internal combustion engines with rocking pistons that are freely located on a central shaft. It has been established, however, that in both of these kinds of implementation, to translate the rocking motion of the pistons or to translate the movement of the revolving pistons into a uniformly rotational movement of the output shaft with the possibility of taking off uniform torque, is very difficult from the practical point of view.

A considerable shared disadvantage of conventional piston motors and of motors with rotating pistons with internal combustion remains the incomplete combustion of the fuel-air mixture but mainly, though, significant escape of unutilized heat that is obtained by the combustion of the fuel-air mixture in these designs of internal combustion engines, which results in their limited effectiveness.

Therefore, the aspiration remains to achieve an as effective as possible utilization of the energy potential of the work medium with the aim of converting it into kinematic motion in driving units that can be used either for mobile machines, or for stationary driving units, which can be used, for instance, for the generation of electrical energy in driving units of electricity generators and other machine assemblies with the aim of obtaining an as high as possible effectiveness with as low as possible thermal losses.

It is, therefore, the object of the invention to create such a driving system that would to a large extent remove the above-mentioned disadvantages and would be structurally and technologically feasible and suitable for industrial use.

A suitable expedient for accomplishing this purpose was found to be a combination of a motor with rocking pistons for function of generating the exhaust gases and a compressor for the generation of pressurized air, and to use the thus prepared energy medium in expansion driving units, such as turbines and similar expansion machines; it is also possible, to advantage, to utilize rotary expansion machines with orbiting blades of such constructions that do not exhibit the usual disadvantages of rotary machines, which reside in the unfavorable take-off of the torque and in the unfavorable friction forces between the ends of the orbiting blades and the orbital surface of the stator; examples of such devices may be rotating machines described, for instance, in patent documents CZ-PS 290702 and CZ-PS 301708.

For the generation of exhaust gases that are to serve as a high-energy medium for driving other expansion drive units, there is, for example, known from the publication Otto-und-Dieselmotoren, ISBN 3-8023-14466-8, chapter 9.3, pages 157 and 158 a system called Freikolben-Gaserzeuger, that describes an apparatus in which exhaust gases are generated using a motor with free pistons, and wherein the generated exhaust gases and air are conveyed into a gas compartment and from there to a gas turbine that forms the drive unit of an electric generator.

Disadvantages of this embodiment can be seen mainly in the difficult regulation of this system and in considerable structural dimensions relative to the assumed output.

From older patent literature, there is known a similar construction from the German patent document DE 920 275 of Junkers Maschinen-und Metallbau G.m.b.H. in which a system is described of a system of a joint motor with free pistons and a compressor for the purpose of obtaining an energy medium destined as a work medium for a gas turbine utilized as the final driving unit for further machine systems requiring the take-off of a rotary motion.

Disadvantages of this implementation are again to be seen in the imperfect regulation of the system.

Another older known similar arrangement is described in the German patent document DE 909 402 to Gerhard Michel, where the substance of the solution resides in an internal combustion engine with free pistons with a collector of compressed air that is conveyed to a pressure vessel and from there to a turbine that is powered by the pressurized air, whereas the excess air is further recuperated back into the circuit.

From newer patent literature, there can be mentioned the implementation of a generator of exhaust gases that is described in the German published application DE-OS 42 26 547 A1 to Josef Lipinski.

It can be said generally that obtaining the energy medium consisting of exhaust gases and air as a source for powering expansion machines by means of gas generators consisting of motors with free pistons, is less suitable, because their common disadvantage of their structure remains the difficult regulation of their running and considerable thermal losses of the energy medium, the price being paid in the lower efficiency of these devices.

One of the most recent solutions aimed at the reduction of the fuel consumption and increasing the efficiency of a motor is being offered by the BMW company in the form of a Turbosteamer system as described in the Technical Weekly No. 18/2011, page 47, which utilizes the waste heat of the exhaust gases and of the cooling water in two additional steam circuits, which increase the output of the motor and reduce the fuel consumption by about 15%. Besides the Turbosteamer technology, there are further published there the Thermoelectric generator, Engine encapsulation a Waste heat exchanger for oil heating technologies. The first two technologies concentrate on obtaining electric energy from the waste heat of the motor, the last one then maximizes the effort for a more rapid heating of the motor and of the oil. Turbosteamer is a system that is supposed to generate electric energy based on the principle of a steam turbine, similarly to that used in electricity generating plants. The work on the system started at the BMW company already in the year 2005 and in its first incarnation used two circuits for obtaining energy. The first high-temperature circuit was utilizing a heat exchanger for obtaining energy from exhaust gases, the second, a low-temperature one, then was obtaining heat from the cooling, system of the motor. In laboratory conditions, the system was able to increase the output of a four-piston motor by about 15%.

A motor with rocking pistons appears to be more suitable for accomplishing an optimum gaining of an energy medium in the form of exhaust gases and air than the classic piston motor or a motor with free oppositely moving pistons. Rocking pistons make it possible to accomplish the combustion process without the need for lubrication, because the pistons exhibit just one degree of freedom of movement from the kinematic point of view. It is possible to provide the working surfaces of the rocking pistons, for instance, with a sprayed ceramic layer that is resistant to high temperatures, and it is simultaneously possible to apply a contactless labyrinthine seal that renders possible high circumferential speeds. Motors with rocking pistons exist in many structural implementations; however, for the aforementioned purposes, it is necessary and advantageous to create such a motor with rocking pistons the function of which would reside solely for the purpose of generating high-energy medium composed of exhaust gases and air, with the possibility of accumulating the same and subsequently using it for powering an expansion machine with orbiting blades that is connected with an electricity generator, in accordance with the spirit of the aim of the present invention. At the same time, the solution aims at creating such a structure that would assure a uniform and regulatable operation of the apparatus with the possibility of heat recuperation.

### ESSENCE OF THE INVENTION

The aforementioned drawbacks are to a large extent eliminated and the purpose of the invention is achieved by a combined driving system of an electric energy generator with the utilization of the pressure potential of a high-energy medium generated in the form of a mixture of exhaust gases and compressed air with the aid of a motor with rocking pistons with an integrated compressor section, consisting of an internal combustion motor with rocking pistons united with a compressor part, where the outlets of the combusted gases as well as of the pressurized air are connected to a thermally insulated pressurized mixing chamber that is further connected with a performance expansion driving unit, to which a performance generator of electric energy is connected, in accordance with the invention the substance of which resides in that the internal combustion motor with rocking pistons is constituted by a common working space in a shared housing of the motor and compressor, in the central portion of which there are formed in a mirrored fashion combustion chambers containing rocking blades of the motor that are rigidly radially supported on a turnable central shaft and in a carrier ring and wherein the rocking blades are to advantage mutually angled with respect to each other and wherein the combustion chambers are delimited on the one side by delimiting partitions radially disposed at the inner circumferential surface of the shared housing of the motor and the compressor and separating the combustion chambers from primary compressor chambers of the primary compressor part, and on the opposite side by a pair of rocking blades at the locations of their lower dead centers, and wherein on the opposite side of the pair of rocking blades there are formed secondary compressor chambers of a secondary compressor part delimited by end parts of a guiding segment provided with secondary suction and outlet channels of a secondary compressor and wherein the turnable central shaft extends with its end portions into external housings of a crankshaft mechanism that are connected in a mirror fashion to the shared housing of the motor and the compressor, where the turnable central shaft is provided with an oscillating yoke having arms that are connected by means of a pair of piston rods with a pair of crankshafts on the outer ends of which there is supported a pair of flywheels that are provided on their peripheries with coils of a stator winding.

The combustion chambers are provided with a pair of regulating elements for the outlet combusted gases of the motor and a pair of suction regulating elements of the motor, and primary compressor chambers are provided with primary regulating elements for the outlet air and with primary suction regulating elements for the air, and the secondary compressor chambers are provided with secondary regulating elements for the outlet air and with secondary suction regulating elements, wherein all of the abovementioned regulating elements are remotely operatable from a central control unit.

A collection outlet piping of the energy medium that opens into a pressurized mixing chamber is connected to the regulating elements for the exhaust gases of the motor, to the primary regulating elements for the outlet air and the secondary regulating elements for the outlet air.

The pressurized mixing chamber that is connected to the outlet of the exhaust gases from the rocking motor and to the outlet of the pressurized air from the compressor part is provided with a main outlet for the energy medium that is connected to the working expansion machine that is connected with a working generator of electric current, and the collection mixing chamber is connected by a relief outlet for the energy medium to an inlet of a relief expansion machine that is connected to a relief generator of electric current that is electrically connected with coils of a stator winding, and the pressurized mixing chamber is provided with a safety overpressure valve.

The advantages of the combined driving system according to the invention reside, above all, in that what is involved here is a working process of a driving unit operating in two basic main, and with recuperation in three, separate stages and it is able to utilize, with high efficiency, the thermal and pressure potential of the working energy medium. The equipment presents the possibility of an optimum regulation of its output at a number of the nodes of the system and, as a result of the dilution of the driving mixture being prepared, there can be expected a significant reduction of the concentration of the combustion products and other harmful substances contained in the fuel during its combustion and it renders possible the use of recuperation when there is excess energy accumulated in the pressurized mixing chamber. Its utilization can be expected, above all, in the energy area.

### OVERVIEW OF THE FIGURES IN THE DRAWING

In the accompanying drawings, there are depicted, for a closer elucidation of the invention, the basic structural elements of the combined driving system and their structural disposition, inclusive of the illustration of the individual operating phases of the rocking motor and associated compressor, wherein FIG. 1 represents, in a cross section C-C evident from FIG. 2, a view of the arrangement of the blades of a rocking motor, of the blades of a primary compressor, and function chambers of a secondary compressor, inclusive of their regulating elements.

In FIG. 2, there is depicted, in a broken axial view A-A, a shared housing of the motor and the compressor, inclusive of outwardly arranged housings for crankshaft mechanisms and flywheels.

FIG. 3 represents, in a cross section B-B, a view of the crankshaft mechanism and FIG. 4 illustrates in an axial section D-D the arrangement of primary compressor chambers and the arrangement of the crankshaft mechanisms.

FIG. 5a and FIG. 5b represents, in a cross section C-C, a view of the compressor parts, wherein there are apparent the primary compressor chambers and the secondary compressor chambers in their upper dead center positions.

FIGS. 6a to 6f illustrate the description of the function in the form of the individual phases of the rocking motor and compressors, and FIG. 7a and FIG. 7b depict, in an axonometric projection, the overall view of the generator of combusted gases.

FIG. 8 represents, in a diagrammatic implementation, the entire combined driving system and the mutual interconnection of the individual structural parts from the source parts of the energy medium all the way to the performance part.

### EXAMPLE OF THE EMBODIMENT OF THE INVENTION

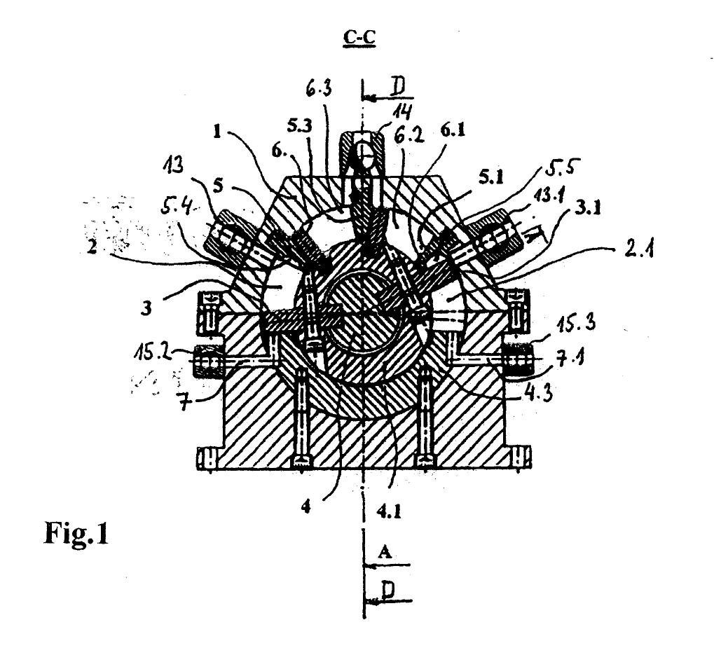

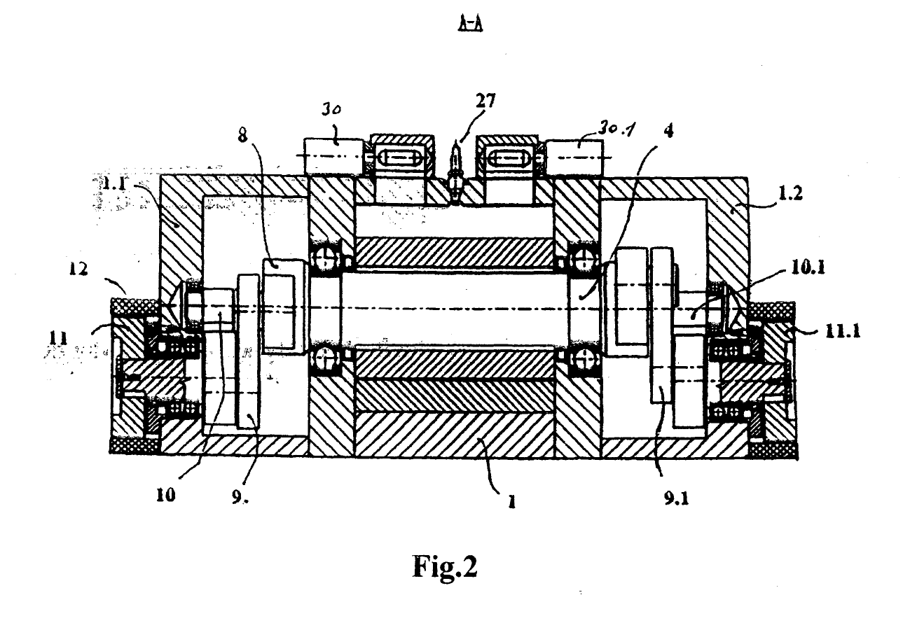

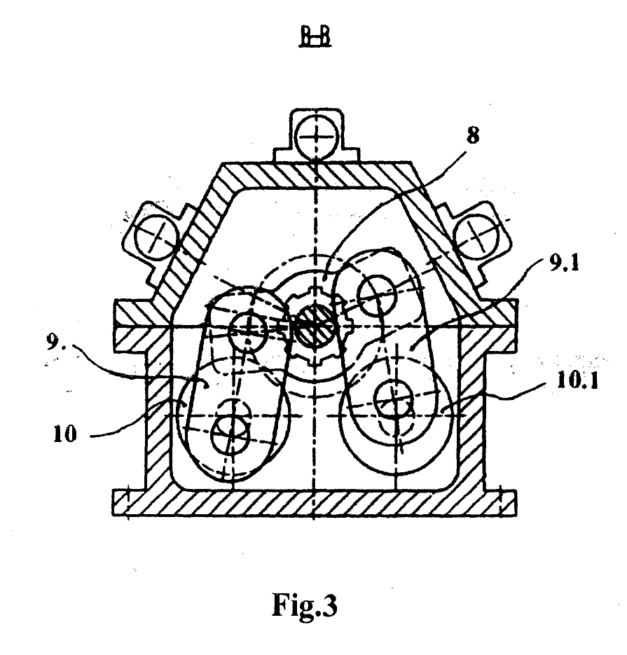

From FIG. 1, there is apparent, in a cross section C-C that is indicated in FIG. 4, a view of the arrangement of the main structural components of a rocking motor, wherein a pair of rocking blades 3, 3.1 of the motor and a pair of rocking blades 6, 6.1 of a primary compressor that move in working chamber 6.2, 6.3 of the primary compressor are rigidly supported in a shared housing 1 on a central shaft 4 and with the intermediary of a carrier ring 4.1. A pair of limiting partitions 5, 5.1 of working chambers 2, 2.1 of the rocking motor and a limiting partition 5.3 of the primary compressor are radially located in the body of the housing 1 on the inner circumferential surface of the latter. The working chambers 2, 2.1 of the motor are delimited at the opposite side by end surfaces of a segment 4.3. The limiting partitions 5, 5.1 of the rocking motor are provided with a recess 5.4, 5.5 that open toward the rocking blades 3, 3.1 of the motor that constitute the compression space of the combustion space of the motor. The upper as well as the lower dead centers of the rocking blades 3, 3.1 of the motor are limited by the stroke of crankshafts 10, 10.1 and the mutual angular adjustment of the arms of an oscillation yoke 8, which is apparent from FIG. 3. On the opposite sides of the rocking blades 3, 3.1 of the motor that are facing away from the recesses 5.4, 5.5, there are formed the working chambers 2, 2.1 of the motor, which simultaneously also constitute the working chambers of a secondary compressor, where suction and expulsion channels 7, 7.1 of the secondary compressor are formed in the segment 4.3 and in the shared housing 1 and they are provided with secondary regulating element 15.2, 15.3 of the secondary compressor. The working chambers 6.2, 6.3 of the primary compressor are provided with a double-acting primary regulating element 14 for the sucked in and output air and the working chambers 2, 2.1 are provided with regulating elements 13, 13.1 for the output combustion gases of the motor and with regulating elements 13.2, 13.3 for the suction of the motor, which are apparent in FIG. 9a and FIG. 9b. The shared housing 1 is advantageously split for assembling reasons. All of the regulating elements are remotely controlled by means of electromagnetic systems situated in a controlling part 30 of a regulating unit that are visible for example in FIG. 2.

FIG. 2 represents, in an angled section A-A indicated in FIG. 1, the structure of the rocking motor, where there may be seen the support of the central shaft 4, at the ends of which, in additional housings 1.1, 1.2, there are supported yokes 8 that are connected with a pair of piston rods 9, 91 that are connected with crankshafts 10, 10.1. Flywheels 11, 11.1 that are provided with coils 12, 12.1 of a stator winding are supported on the output ends of the crankshafts 10, 10.1. A sparkplug 27 of the motor is located in the central region of the shared housing 1, and actuating parts 30, 30.1 of the regulating elements are visible at the regulating elements 13, 13.1 for the output combusted gases of the motor and at the regulating elements 13.2, 13.3 for the suction of the motor.

In FIG. 3, there is illustrated, in a cross section B-B indicated in FIG. 4, the implementation of a crankshaft mechanism, wherein there is visible an oscillating yoke 8 with mutually angularly adjusted arms that are connected by means of rods 9, 9.1 with crankshafts 10, 10.1.

FIG. 4 depicts, in an axial vertical section D-D, the implementation of the compressor part with a rocking blade 6.1 of the primary compressor, and where there are further depicted double-acting regulating elements 14, 14.1 of the primary compressor.

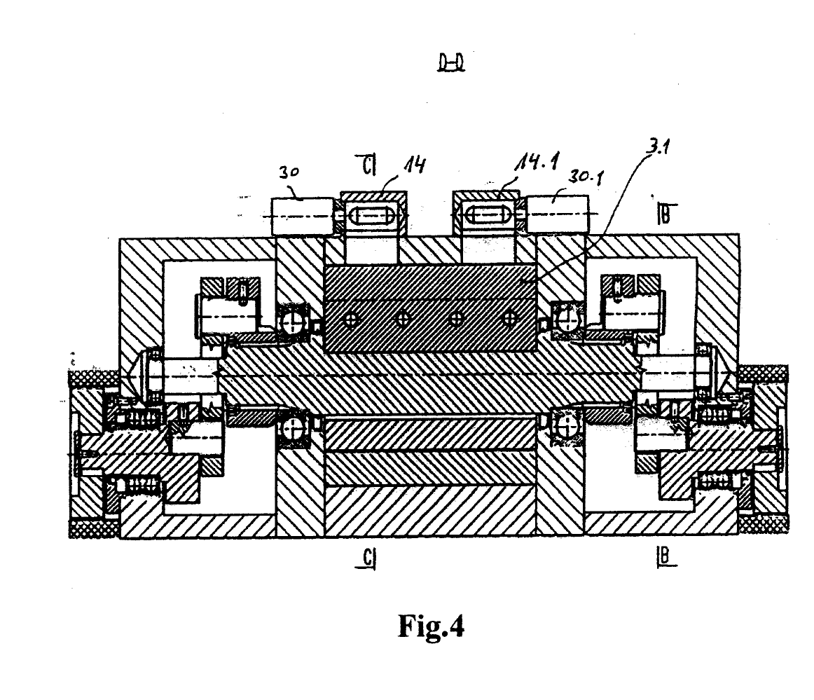

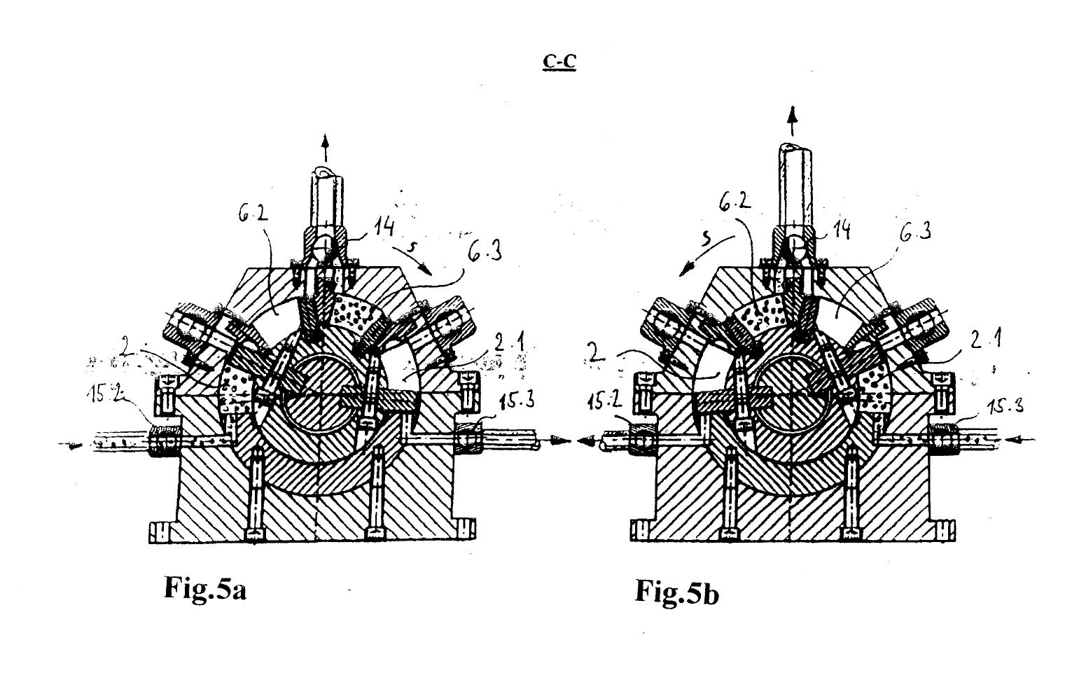

In FIG. 5a and FIG. 5b, there are depicted working chambers 6.2, 6.3 in its limiting phases and working chambers 2, 2.1 of the secondary compressor, and where there is visible the configuration of a double-acting regulating element 14 and the configuration of the secondary regulating elements 15.2, 15.3.

The primary compressor and the secondary compressor operate in a double stroke cycle—suction and expulsion, and, with the aid of the corresponding regulating element, supply the pressurized air into a pressurized mixing chamber 17.

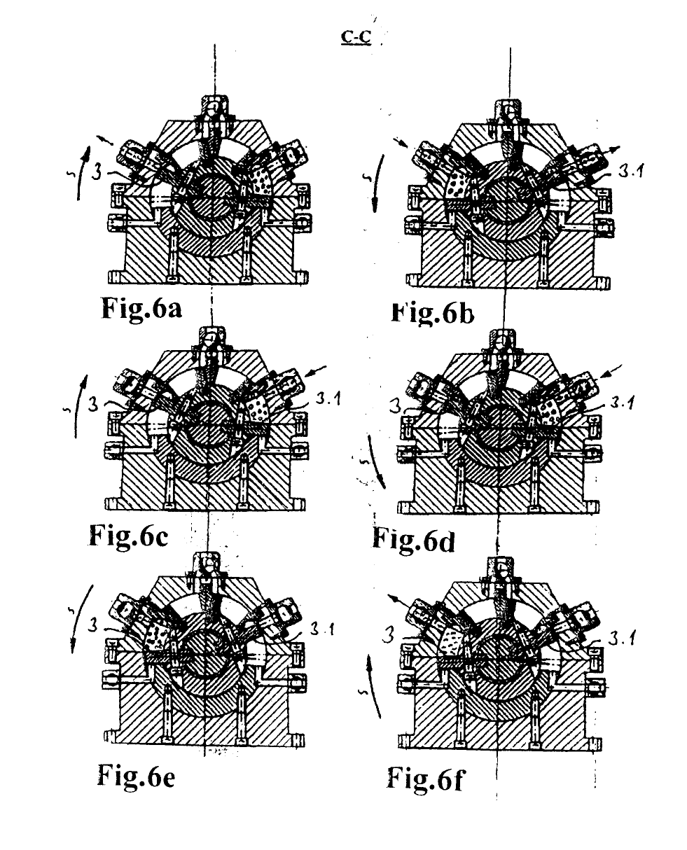

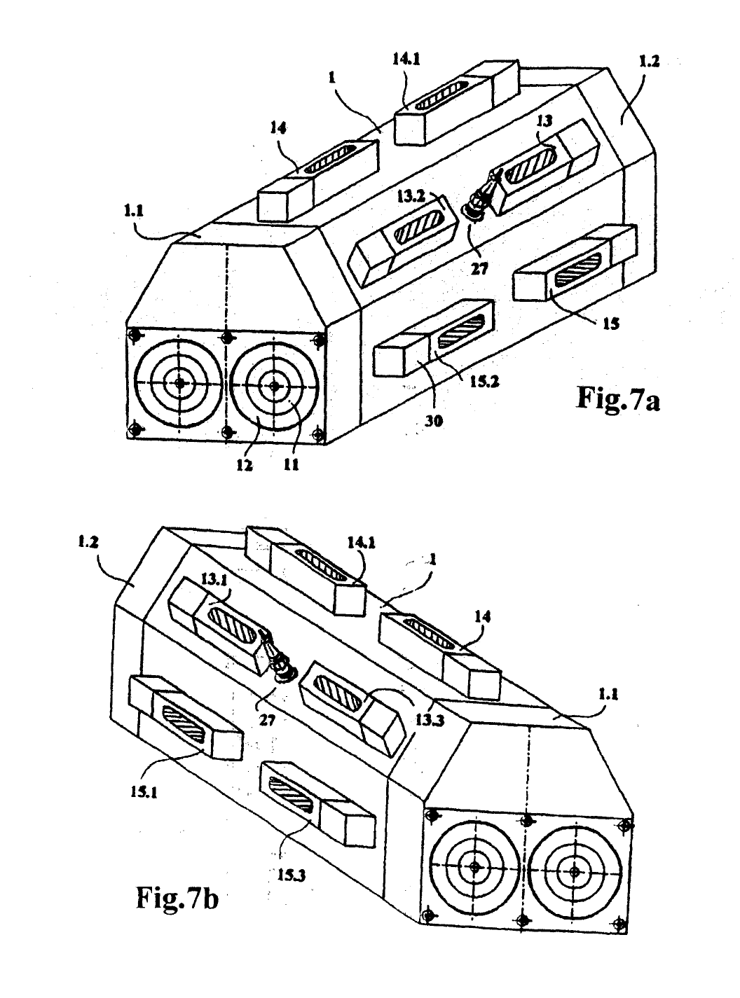

FIG. 6a to FIG. 6f represent the individual phases of the rocking motor in the course of its action as a generator of combusted gases, wherein FIG. 6a presents the expulsion phase in the direction s of rotation of the motor when the blade 3 of the rocking motor is in its upper dead center. FIG. 6b depicts, the blade 3 of the rocking motor during the suction phase in the course of rotation in the opposite direction s′. In FIG. 6c there is visible the blade 3 of the rocking motor during the compression phase once more in the original direction s of rotation and FIG. 3d represents the configuration of the blade 3 of the rocking motor once more in the opposite direction s′ of rotation. FIG. 6e represents the expansion phase when the blade 3 of the rocking machine is, in the direction s in the lower dead center and FIG. 6f depicts the final phase of the expansion when the blade 3 of the rocking motor is situated in the lower dead center prior to the return to the upper dead center that concludes this phase by the expulsion once more in the original direction s of rotation.

It is possible to proclaim that the blade 3 of the rocking motor oscillates in one direction s and in the opposite direction s′. The symmetrically arranged blade 3.1 of the rocking motor in the other half of the shared housing 1, which is subdivided for these purposes by a vertical symmetry axis, operates with a delay by one phase, but in a fully identical manner, and they deliver the combusted gases through an exhaust into the pressurized mixing chamber 17.

FIG. 7a and FIG. 7b represent, in an axonometric projection, the overall view of the generator of an energy medium in a shared housing 1 and additional housings 1.1, 1.2 for the crankshaft mechanisms, wherein there is apparent the disposition of the double-acting regulating elements 14, 14.1 of the primary compressor, the disposition of the regulating elements 13, 13.1 for the exiting combusted gases of the motor, and the regulating elements 15, 15.1 for the motor suction, the disposition of the sparkplug 27, and the disposition of the secondary regulating elements 15, 15.1 for the exiting air of the secondary compressor and of the suction regulating element 15.2, 15.3 of the secondary compressor.

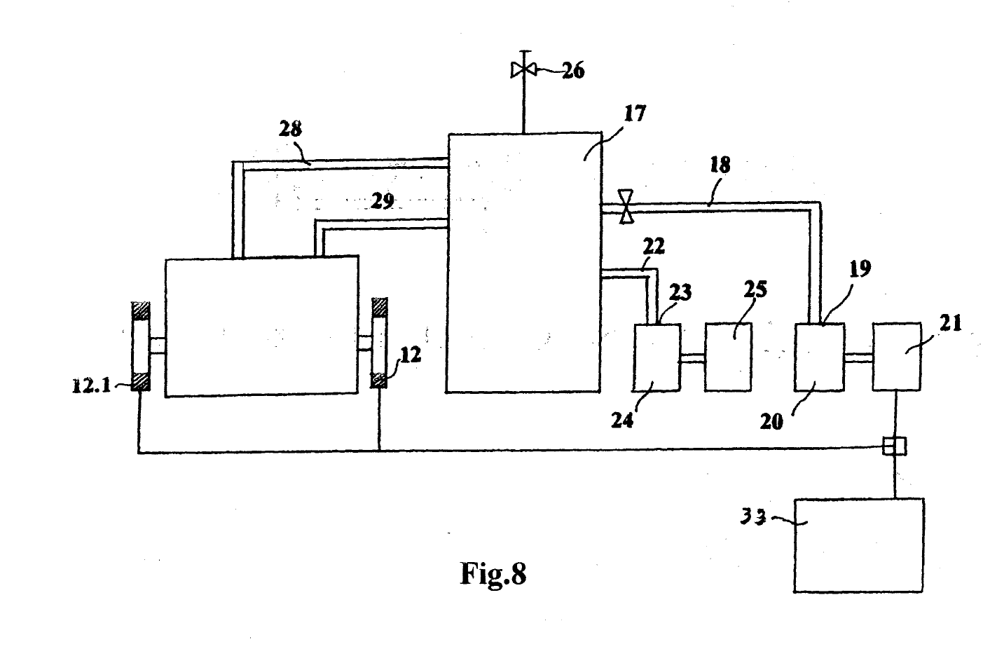

FIG. 8 illustrates, in a diagrammatic fashion, the mutual interconnections of the main components of the combined driving system, wherein there is visible the shared housing 1, in which there are accommodated the rocking motor with the primary and secondary compressor. The outlet 28 for the combusted gases of the rocking motor and the outlet 29 for the pressurized air from the primary and secondary compressors are connected to a pressurized mixing chamber 17 that is equipped with an overpressure safety valve 26 and a thermally insulating sheathing. An outlet 22 from the pressurized mixing chamber 17 is connected to an inlet 23 of the performance expansion machine 24 that is connected with a performance generator 25 of electric current, and further an outlet 18 for the energy medium from the pressurized mixing chamber 17 is connected through a bypass relief valve 32 to an inlet 19 of a relief expansion machine 20 that is connected to a relief generator 21 od electric current. The relief generator 21 of electric current is electrically connected with coils 12, 12.1 of a stator winding and with a backup accumulator 33.

The combined driving system in accordance with the invention operates in three stages that are independent of one another.

During the first stage, the rocking motor performs the function of a generator of combusted gases and the primary compressor and the secondary compressor that are coupled with the rocking motor on a shared central shaft 4 supply the pressurized mixing chamber 17, through the outlet 28 for the combusted gases and the outlet 29 for the pressurized air, with a highly pressurized energy medium, consisting of the pressure potential of the air and the heat potential of the combusted gases. In this manner, the most significant part of the waste heat coming into existence as a result of the combustion process is accumulated in this way, together with the compresses air, in the thermally insulated pressurized mixing chamber 17, with only a minimum heat exchange with the outer environment.

During the second stage, the working energy medium is supplied through the outlet 22 for the energy medium pressure and thermal potential into the performance expansion machine 24 with its own power regulation, which is connected to the performance generator 24 of electric current that generates the electric energy for a network.

In the third stage, the driving system renders possible the recuperation of the working energy medium in the pressurized mixing chamber 17 in the form of its conversion into electrical energy, which in this case serves for the maintenance of the level of kinetic energy with the aid of flywheel systems that ase connected by means of the coils 12, 12.1 of the stator winding to a pair of flywheels 11, 11.1 that, are supported on crankshafts 10, 10.1 of the rocking motor and that are supplied with electric energy with the aid of the relief generator 21 of electric current that is connected to the relief expansion machine 20. When this excess of recuperation energy is encountered, it is possible to purposely interrupt the supply of the fuel into the rocking motor and let just the flywheel system do the work.

It is possibly to generally assume that the combined driving system according to the invention exhibits, due to the substantial dilution of the working medium, lower emission values, which brings about a significant ecological aspect of the driving system and a considerable increase in the efficiency of this driving unit, augmented by the substantial utilization of the energy potential of the working energy medium with minimum heat losses to the environment.

### REFERENCE CHARACTERS

1—shared housing of motor and compressor
1.1, 1.2—a pair of housings for the crankshafts
2, 2.1—combustion chambers of the motor
3, 3.1—a pair of rocking blades of the motor
4—central turnable shaft
4.1—carrier ring
5, 5.1—limiting partitions of the motor
5.4, 5.5—recess of the compression space of the motor
5.3—limiting partition of the primary compressor
6, 6.1—a pair of rocking blades of the primary compressor
6.2, 6.3—working chambers of the primary compressor
7, 7.1—suction and ejection channels of the secondary compressor
8—oscillating yoke
9, 9.1—a pair of piston rods
10, 10.1—a pair of crankshafts
11, 11.1—a pair of flywheels
12, 12.1—coils of stator winding
13, 13.1—regulating elements for the outlet combusted gases of the motor
13.2, 13.3—regulating elements for the suction of the motor
14, 14.1—double-acting regulating elements of the primary compressor
15, 15.1—secondary regulating elements for the outlet air of the secondary compressor
15.2, 15.3—secondary suction regulating elements for the air of the secondary compressor
17—pressurized mixing chamber
18—outlet of the energy medium from the relief expansion machine
19—inlet of the energy medium to the relief expansion machine
19.1, 19.2—secondary suction and outler channels of the secondary compressor
20—relief expansion machine
21—relief generator of electric current
22—outlet for the energy medium of the performance expansion machine
23—inlet of the performance expansion machine
24—performance expansion machine
25—performance generator of electric current
26—excessive pressure safety valve
27—sparkplug
28—outlet for the combusted gases of the motor
29—outlet for the pressurized air of the compressor
30, 31—actuating parts of the regulating unit
32—bypass relief valve
33—accumulator
s—direction of rotation of the motor
s′—opposite direction of rotation of the motor

1. Combined driving system of an electric energy generator with the utilization of the pressure potential of a high-energy medium generated in the form of a mixture of exhaust gases and compressed air with the aid of a motor with rocking pistons with an integrated compressor section, consisting of an internal combustion motor with rocking pistons united with a compressor part, where the outlets of the combusted gases as well as of the pressurized air are connected to a thermally insulated pressurized mixing chamber that is further connected with a performance expansion driving unit, to which a performance generator of electric energy is connected, characterized in that the internal combustion motor with rocking pistons is constituted by a common working space in a shared housing (1) of the motor and compressor, in the central portion there are formed in a mirrored fashion combustion chambers (2, 2.1) containing rocking blades (3, 3.1) of the motor that are rigidly radially supported on a turnable central shaft (4) and in a carrier ring (4.1) and wherein the rocking blades (3, 3.1) are to advantage mutually angled with respect to each other and wherein the combustion chambers (2, 2.1) are delimited on the one side by delimiting partitions (5, 5.1) radially disposed at the inner circumferential surface of the shared housing (1) of the motor and the compressor and separating the combustion chambers (2, 2.1) from primary compressor chambers (6, 6.1) of the primary compressor part, and on the opposite side by a pair of rocking blades (3, 3.1) at the locations of their lower dead centers, and wherein on the opposite side of the pair of rocking blades (3, 3.1) there are formed secondary compressor chambers (7, 7.1) of a secondary compressor part delimited by end parts of a guiding segment (18) provided with secondary suction and outlet channels (19, 19.1) of a secondary compressor and wherein the turnable central shaft (4) extends with its end portions into external housings (1.1, 1.2) of a crankshaft mechanism that are connected in a mirror fashion to the shared housing (1) of the motor and the compressor, where the turnable central shaft (4) is provided with an oscillating yoke (8) having arms that are connected by means of a pair of piston rods (9, 9.1) with a pair of crankshafts (10, 10.1) on the outer ends of which there is supported a pair of flywheels (11, 11.1) that are provided on their peripheries with coils (12, 12.1) of a stator winding.

2. Combined driving system according to claim 1, characterized in that the combustion chambers (2, 2.1) are provided with a pair of regulating elements (13, 13.1) for the outlet combusted gases of the motor and a pair of suction regulating elements (13.2, 13.3) of the motor and primary compressor chambers (6, 6.1) are provided with primary regulating elements (14, 14.1) for the outlet air and with primary suction regulating elements (14.2, 14.3) for the air and the secondary compressor chambers (7, 7.1) are provided with secondary regulating elements (15, 15.1) for the outlet air and with secondary suction regulating elements (15.2, 15.3), wherein all of the abovementioned regulating elements are remotely operatable from a central control unit.

3. Combined driving system according to claim 2, characterized in that a collection outlet piping of the energy medium that opens into a pressurized mixing chamber (17) is connected to the regulating elements (13, 13.1) for the exhaust gases of the motor, to the primary regulating elements (14, 14.1) for the outlet air and the secondary regulating elements (15, 15.1) for the outlet air.

4. Combined driving system according to claim 3, characterized in that the pressurized mixing chamber (17) that is connected to the outlet (28) of the exhaust gases from the rocking motor and to the outlet (29) of the pressurized air from the compressor part is provided with a main outlet (22) for the energy medium that is connected to the performance expansion machine (23) that is connected with a performance generator (25) of electric current, and the collection mixing chamber (17) is connected by a relief outlet (18) for the energy medium to an inlet (19) of a relief expansion machine (20) that is connected to a relief generator (21) of electric current that is electrically connected with coils (12, 12.1) of a stator winding.

5. Combined driving system according to claim 4, characterized in that the pressurized mixing chamber (17) is provided with a safety overpressure valve (26).
